(19) United States
(12) Patent Application Publication
(10) Pub. No.: US 2007/0157285 A1
(43) Pub. Date: Jul. 5, 2007

(54) Distribution of multimedia content

(75) Inventors: Michael O. Frank, Minnetonka, MN (US); Mark W. Teskey, Chaska, MN (US); Bradley R. Smith, Richfield, MN (US); George C. Hipp, Minneapolis, MN (US); Wade Fenn, Excelsior, MN (US); Jason R. Tell, Birchwood, MN (US); Lori L. Baker, Minneapolis, MN (US)

Correspondence Address: SCHWEGMAN, LUNDBERG, WOESSNER & KLUTH, P.A., P.O. BOX 2938, MINNEAPOLIS, MN, 55402, US

(73) Assignee: The Navvo Group LLC

(21) Appl. No.: 11/325,241

(22) Filed: Jan. 3, 2006

(51) Int. Cl. H04N 7/08; H04N 7/173; H04N 7/18; G06F 15/00; H04N 7/16; G06F 17/00

(52) U.S. Cl. 725/138; 715/500.1; 715/501.1; 725/81; 725/137; 725/131

(57) ABSTRACT

Systems, apparatus and methods for distribution of multimedia content are described herein. In some embodiments, a method includes receiving, into a device having two or more modes of interaction, an input request for multimedia content from one mode of the two more modes of interaction. The method also includes transmitting the input request to a multimedia content provider. The method includes receiving the multimedia content back from the multimedia content provider. The method includes updating each of the two or more modes of interaction based on the received multimedia content.

### RELATED APPLICATION

This application is related to U.S. application Ser. No. ______ filed on even date herewith, titled “Distribution and Interface for Multimedia Content and Associated Context.”

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

1. Field

This invention relates generally to the field of data processing and more particularly to distribution of multimedia content.

2. Description of Related Art

There are a variety of different types of multimedia content that consumers can now access. Examples of such multimedia content include music, video, etc.

### SUMMARY

Systems, apparatus and methods for distribution of multimedia content are described herein. In some embodiments, a method includes receiving, into a device having two or more modes of interaction, an input request for multimedia content from one mode of the two more modes of interaction. The method also includes transmitting the input request to a multimedia content provider. The method includes receiving the multimedia content back from the multimedia content provider. The method includes updating each of the two or more modes of interaction based on the received multimedia content.

In some embodiments, a method includes setting a communication channel of a wireless communication device to a configuration channel in response to a determination that communication cannot be established with a wireless network. The method includes receiving wireless configuration data from a different wireless communication device on the wireless network. The method also includes updating wireless configuration of the wireless communication device to connect to the wireless network based on the received wireless configuration data.

In some embodiments, an apparatus includes a wireless communication module to receive a wireless communication, from an electronic device, that cannot be transmitted through an opaque material. The wireless communication includes an identification of the electronic device. The apparatus also includes an output module to transmit a wireless control communication to control the electronic device after the wireless communication is received by the apparatus.

### BRIEF DESCRIPTION OF THE FIGURES

The present invention is illustrated by way of example and not limitation in the Figures of the accompanying drawings in which:

FIG. 1 is a block diagram illustrating a system for controlling the distribution of multimedia content across multiple zones, according to some embodiments of the invention.

FIG. 2 illustrates parts of a multimedia controller, according to some embodiments of the invention.

FIG. 3 illustrates parts of a multimedia receiver, according to some embodiments of the invention.

FIG. 4 illustrates parts of an electronic device to be detected in a zone, according to some embodiments of the invention.

FIG. 5 illustrates a flow diagram for multimodal processing, according to some embodiments of the invention.

FIG. 6 illustrates a flow diagram for synthesis of multiple multimedia output, according to some embodiments of the invention.

FIG. 7 illustrates a flow diagram of operations of a device to be configured for a wireless network, according to some embodiments of the invention.

FIG. 8 illustrates a flow diagram of operations of a device to configure other devices for a wireless network, according to some embodiments of the invention.

FIG. 9 is a block diagram illustrating a system for detecting electronic devices in a zone, according to some embodiments of the invention.

FIG. 10 illustrates a flow diagram of operations of an electronic device to be detected and subsequently controlled by a multimedia controller, according to some embodiments of the invention.

FIG. 11 illustrates a flow diagram of operations of a multimedia controller to detect and subsequently control electronic devices in a zone, according to some embodiments of the invention.

FIG. 12 illustrates a flow diagram of operations of a multimedia device for displaying of a contextual user output interface, according to some embodiments of the invention.

FIG. 13 illustrates a structure for mapping of relationships among multimedia content, according to some embodiments of the invention.

FIG. 14 illustrates a graphical user interface of a display of a result of scores of professional football and its context, according to some embodiments of the invention.

FIG. 15 illustrates a graphical user interface of a display of a result of a user's stocks and its context, according to some embodiments of the invention.

### DESCRIPTION OF THE EMBODIMENTS

Systems, apparatus and methods for distribution of multimedia content are described herein. This description of the embodiments is divided into seven sections. The first section describes an example system environment and device architectures. The second section describes example operations of multimodal processing. The third section describes example operations of synthesis of multiple multimedia output. The fourth section describes example operations of a wireless configuration of unconfigured electronic devices. The fifth section describes example operations of detection of devices in a zone. The sixth section describes example operations of displaying a contextual user output interface. The seventh section provides some general comments.

Some embodiments may be used in the control of the distribution of multimedia content. For example, some embodiments may be used as part of a home entertainment and information system. The multimedia controller may control the distribution of different multimedia from various multimedia content providers to different zones. For example, in some embodiments, the multimedia controller may control the distribution of video, audio, etc. from a home computer to different rooms in a home. The distribution may be through wireless or wired communication. For example, in some embodiments, the distribution may be through a wireless router. The system may also include one or more multimedia receivers in the one or more zones for receiving the multimedia content. For example, for audio the multimedia receivers may be coupled to a stereo for outputting audio there from. The system may allow for access to a digital music collection on a home computer, the latest news headlines and weather reports, on-demand stocks and mutual fund performance, up-to-the-minute sports scores, schedules and news, etc.

A user of the system may control how to receive the content. For example, a user may play music through a given set of speakers or use headphones to listen privately through the multimedia controller. Furthermore, the user may view a stock report on a display on the multimedia controller or have such report read through an audio output on the multimedia controller.

In some embodiments, the multimedia controller is multimodal. In other words, the multimedia controller may include multiple modes of interaction (e.g., voice, buttons, keyboard, etc.) for both input and output for the controlling of the system. The different modes of interaction may be dynamically updated as a user navigates through the system. Accordingly, at any point in the operation of the system, a user may use voice, buttons, etc. for navigation. For example, a user may use voice input for an initial broad search that returns a list of results (such as all songs for a particular artist). The user may then use the buttons to select one of the songs from the list.

In some embodiments, the distributed multimedia content may be of different priorities. For example, music may be low priority, while stock quotes, alarms, news, etc. may be high priority. In some embodiments, the low priority and high priority multimedia content is synthesized and then output as audio.

In some embodiments, the system includes a wireless configuration of the multimedia receivers and/or other electronic devices in different zones. In particular, the multimedia controller may configure the multimedia receivers/electronic devices to communicate on a wireless network. Accordingly, a user is not required to manually set up a wireless configuration for each of the multimedia receivers/electronic devices that are added to the system.

Some embodiments include a detection of electronic devices (such as the multimedia receivers) using a wireless remote control (such as the multimedia controller) in a zone of a multi-zone system. The electronic devices may emit a wireless transmission (such as an infrared signal) that the wireless remote control may detect. In some embodiments, the wireless transmission may be limited to be within the zone where the electronic device is located. Accordingly, a user may move the wireless remote control from zone to zone and then detect and control the electronic devices within a given zone. In particular, the wireless remote control may be configured to control the devices in a given zone after receipt of the wireless transmissions from such devices in the zone.

Some embodiments provide a context for a user. In particular, in some embodiments, a user may jump to any point in a database of multimedia content. For example, the user is not required to step through a tree structure of data to retrieve certain multimedia content that may be located a number of levels therein. To illustrate, the user may request a list of the professional football scores. Therefore, the request may return this list along with a context. For example, in some embodiments, the context may include the data that is a level before and a level after the requested data. A display may include the result and the context. Accordingly, the user has a context of where they are positioned in the multimedia content, for subsequent requests for multimedia content. In some embodiments, the user may use a voice input to jump to any point in a database of multimedia content.

In some embodiments, one or more groups may be defined for the distribution of multimedia content. The groups may be defined prior to the distribution of such content. Accordingly, a user may define groups, which may include one, more than one, less than all, all zones in a given system. For example, a group may be all of the rooms on a given floor, the living room and kitchen, etc.

### Example System Environment and Device Architectures

### Example System Environment

This section provides an example system environment in which embodiments of the invention can be practiced. This section also describes an example system environment for the multimedia controller and the multimedia receivers. Operations of the system components are described in the subsequent sections.

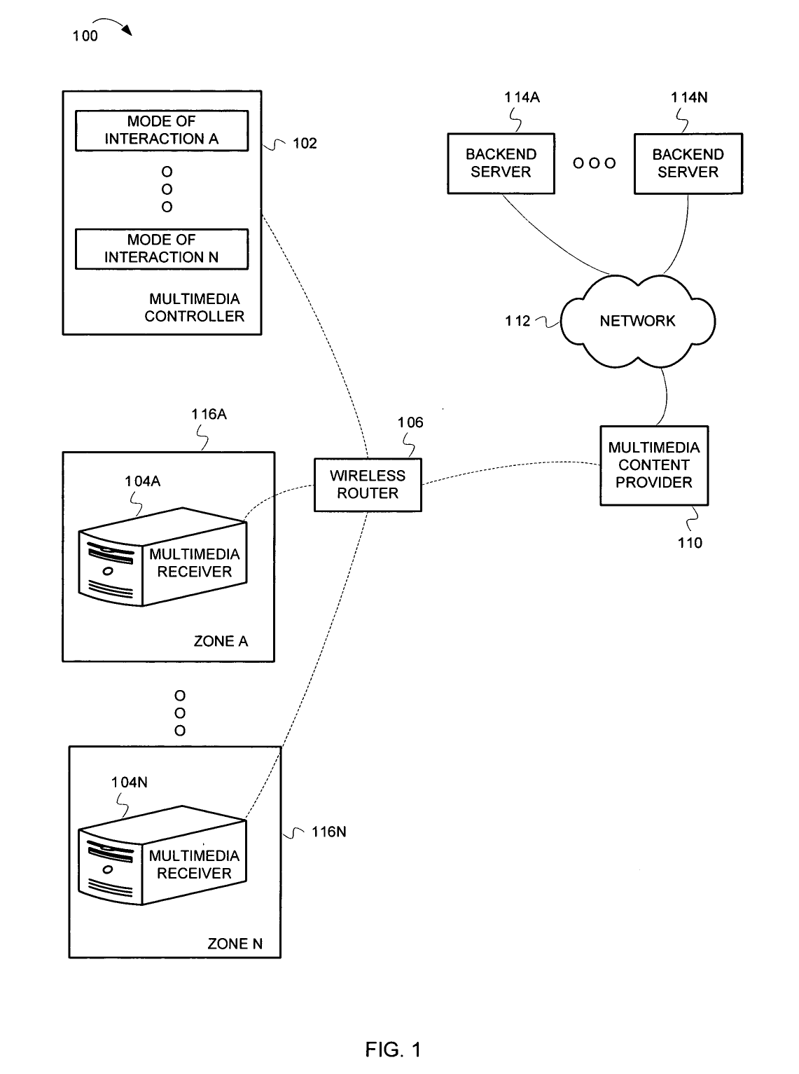

FIG. 1 is a block diagram illustrating a system for controlling the distribution of multimedia content across multiple zones, according to some embodiments of the invention. A system 100 includes a multimedia controller 102, a number of multimedia receivers 104A-104N, a wireless router 106, a multimedia content provider 110 and a number of backend servers 114A-114N. The multimedia controller 102, the multimedia receivers 104 and the multimedia content provider 110 are coupled together through wireless communication using the wireless router 106. However, in some embodiments, all or some of the communications among such components may be wired.

The multimedia content provider 110 may be any type of device for supplying multimedia content (including, but not limited to, audio (such as songs, news reports, sports scores, weather, traffic, etc.), video (such as movies, news broadcasts, etc.), etc. In some embodiments, the multimedia content provider 110 may be a personal computer (such as a desktop or notebook computer).

As shown, the multimedia receivers 104 may be in different zones. For example, the multimedia receivers 104 may be in different rooms or parts of a home, office, etc. The multimedia receiver 104A and the multimedia receiver 104A are located in a zone A 116A and a zone N 116N, respectively.

The multimedia content provider 110 is also coupled to the backend servers 114A-114N through a network 112. The communication between such components may be wireless, wired or a combination thereof. The network 112 may be a local area network, a wide area network, etc. For example, the network 112 may be the Internet. Accordingly, the multimedia content provider 110 may retrieve multimedia content from the backend servers 114.

As shown, the multimedia controller 102 may have multiple modes of interactions (mode of interaction A, . . . mode of interaction N). The modes of interaction may be a microphone for inputting voice, buttons, a keyboards, stylus pens, etc. for input, a display and speakers for outputting images/video and audio, respectively, etc.

A user may use any modes of interaction while using the multimedia controller 102. The user may use a voice input for the control. The voice input may be forwarded to the multimedia content provider 110. The multimedia content provider 110 may include voice recognition logic (software, hardware or a combination thereof) for interpreting the voice request/command. In some embodiments, after a number of requests from the user are considered errors, the multimedia controller 102 may enter a training mode. For example, if the voice recognition logic in the multimedia content provider 110 is not able to recognize the command, the request may be marked as an error. Alternatively or in addition, the user may mark the request as an error based on the result returned. The training mode may enable to interact with the multimedia controller 102 to allow the multimedia content provider 110 to recognize the voice of the user. For example, a user could voice test commands.

In some embodiments, a user selects a button on the multimedia controller 102 for inputting a voice request. A cursor on the graphical user interface of the display of the multimedia controller 102 may be changed to a “preparing to record” symbol until the multimedia controller 102 is prepared to receive the voice input. Such symbol signifies to the user that the multimedia controller 102 is not prepared to receive voice input. After the cursor changes to a “ready to record” symbol, such change signifies to the user to input the voice request. In some embodiments, the multimedia controller 102 commences recording the voice a given time period prior to the change to the “ready to record” symbol. In some embodiments, the time period may be one millisecond, two milliseconds, three milliseconds, one second, two second, etc. Such embodiments ensure that the multimedia controller 102 is able to record at the beginning of the voice request, if the user speaks after the change to the “ready to record” symbol.

In some embodiments, the voice request may include the location where the multimedia content is to be distributed (e.g., to a multimedia receiver 104 in a given zone). For example, the user may request—“Play song A by artist B in the kitchen.” The multimedia content provider 110 may distribute the multimedia content to the particular multimedia controller/receiver (after the parsing by the voice recognition logic).

In some embodiments, the modes of interaction for returning a result of a request may include data that may be displayed on a graphical user interface of a display of the multimedia controller 102, an audio output to the multimedia controller 102/multimedia receiver 104, etc. In some embodiments, the audio output may be a sports score, business news, local news, weather, traffic, etc. The voices for such data may be different persons, which is dependent on the type of audio output. For example, a sports personality may be the voice that is audio output for the sports scores, while a business personality may be the voice that is audio output for the business news.

In some embodiments, the results played back to the multimedia controller 102/multimedia receivers 104 may be a user-customized set of different multimedia content. For example, the user may configure the system 100 to have the local news, weather and traffic be output to the multimedia receiver 104 in the bedroom each morning at 7 a.m. In some embodiments, the multimedia receivers 104 may be part of an alarm clock. Accordingly, after the alarm is output through a multimedia receiver 104, this aggregated multimedia content may be subsequently output.

In some embodiments, after the multimedia controller 102 is powered on after prior usage, the zones where multimedia content was previously distributed is displayed on the display of the multimedia controller 102 as part of the graphical user interface. In some embodiments, after the multimedia controller 102 is powered on after prior usage, a list of favorite multimedia content, zones where multimedia content is most distributed, etc. is displayed on the display of the multimedia controller 102 as part of the graphical user interface.

In some embodiments, voice commands input by the user into the multimedia controller 102 may be mapped to user-customized data. For example, the names for the user-customized set of different multimedia content (as described above), the names of zones, etc. may be mapped to voice commands. In some embodiments, the voice commands may be mapped to any of the buttons and soft keys on the multimedia controller 102.

### Example Multimedia Controller

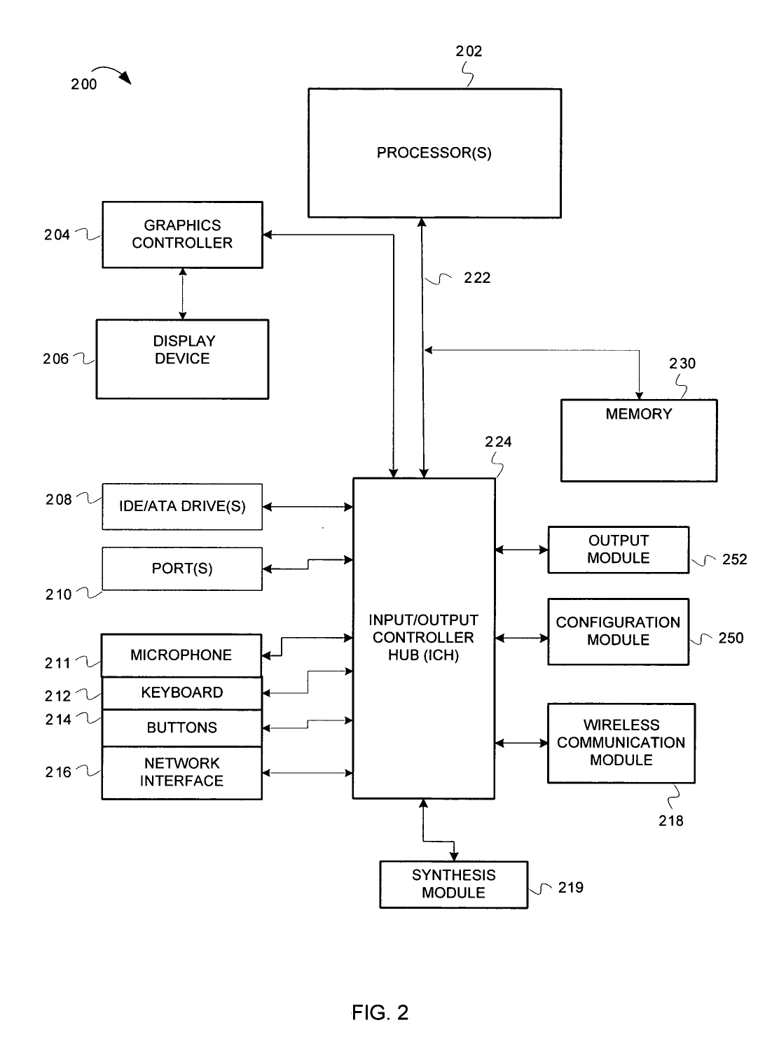

FIG. 2 illustrates parts of a multimedia controller, according to some embodiments of the invention. In particular, a multimedia controller 200 shown in FIG. 2 may be representative of an architecture within the multimedia controller 102. The multimedia controller 200 comprises processor(s) 202.

The multimedia controller 200 also includes a volatile memory 230, processor bus 222, and an Input/Output (I/O) controller hub (ICH) 224. The processor(s) 202, the volatile memory 230, and the ICH 224 are coupled to the processor bus 222. The processor(s) 202 may comprise any suitable processor architecture. The multimedia controller 200 may comprise one, two, three, or more processors, any of which may execute a set of instructions in accordance with embodiments of the invention. The processor(s) 202 may be different types of processors. For example, a first processor may be a general purpose processor, while a second processor may be a digital signal processor for decoding and encoding audio data, video data, etc.

The memory 230 may be representative of volatile and/or nonvolatile memory that stores data and/or instructions, and may comprise any suitable memory, such as a dynamic random access memory (DRAM), etc. The nonvolatile memory may be Static Random Access Memory (SRAM), flash memory, etc. The nonvolatile memory may also be Programmable ROM (PROM), Erasable PROM (EPROM), Electrically Erasable PROM (EEPROM), etc.

The multimedia controller 200 may include a wireless communication module 218, a synthesis module 219, a configuration module 250 and an output module 252. The wireless communication module 218, the synthesis module 219, the configuration module 250 and the output module 252 may be representative of hardware, firmware or a combination thereof. The wireless communication module 218, the synthesis module 219, the configuration module 250 and the output module 252 may be software instructions that reside in the memory 230 and/or one of the IDE/ATA drives 208, which may be executed by the processor(s) 202. The operations of the wireless communication module 218, the synthesis module 219, the configuration module 250 and the output module 252 are described in more detail below.

A graphics controller 204 controls the display of information on a display device 206, according to some embodiments of the invention. The ICH 224 provides an interface to I/O devices or peripheral components for the multimedia controller 200. The ICH 224 may comprise any suitable interface controller to provide for any suitable communication link to the processor(s) 202, the volatile memory 230 and/or to any suitable device or component in communication with the ICH 224. In some embodiments, the ICH 224 provides suitable arbitration and buffering for each interface.

For some embodiments of the invention, the ICH 224 provides an interface to a secondary storage 208 (which may be any type of nonvolatile data storage), such as a hard disk drive (HDD) or compact disc read only memory (CD ROM) drive, or to suitable universal serial bus (USB) devices through one or more USB ports. The secondary storage 208 may be read only, read/write, etc.

For some embodiments, the ICH 224 also provides an interface different user input devices (a microphone 211, a keyboard 212, buttons 214, etc.). For some embodiments, the ICH 224 also provides a network interface 220 though which the multimedia controller 200 may communicate with other computers and/or devices. The multimedia controller 200 may also include a wireless communication module 218. The wireless communication module 218 may be hardware, software, firmware or a combination thereof to configure data communication according to one or more wireless protocols through the network interface 216. The ICH 224 may provide an interface to any number of ports 210. The ports 210 may be used to provide different input/output. For example, one or more ports 210 may be coupled to speakers for audio output.

In some embodiments, the multimedia controller 200 includes a machine-readable medium that stores a set of instructions (e.g., software) embodying any one, or all, of the methodologies for the operations described herein. Furthermore, software may reside, completely or at least partially, within memory unit 230 and/or within the processor(s) 202.

With regard to the multimedia content provider 110, while not shown in a detailed diagram, the multimedia content provider 110 may include components similar to those shown in FIG. 2 for the multimedia controller 200. For example, the multimedia content provider 110 may include processor(s), machine-readable media (such as memory, secondary storage) for storage of data (including different types of multimedia content), software to execute on the processor(s) for operations described therein, various input/output, etc.

### Example Multimedia Receiver

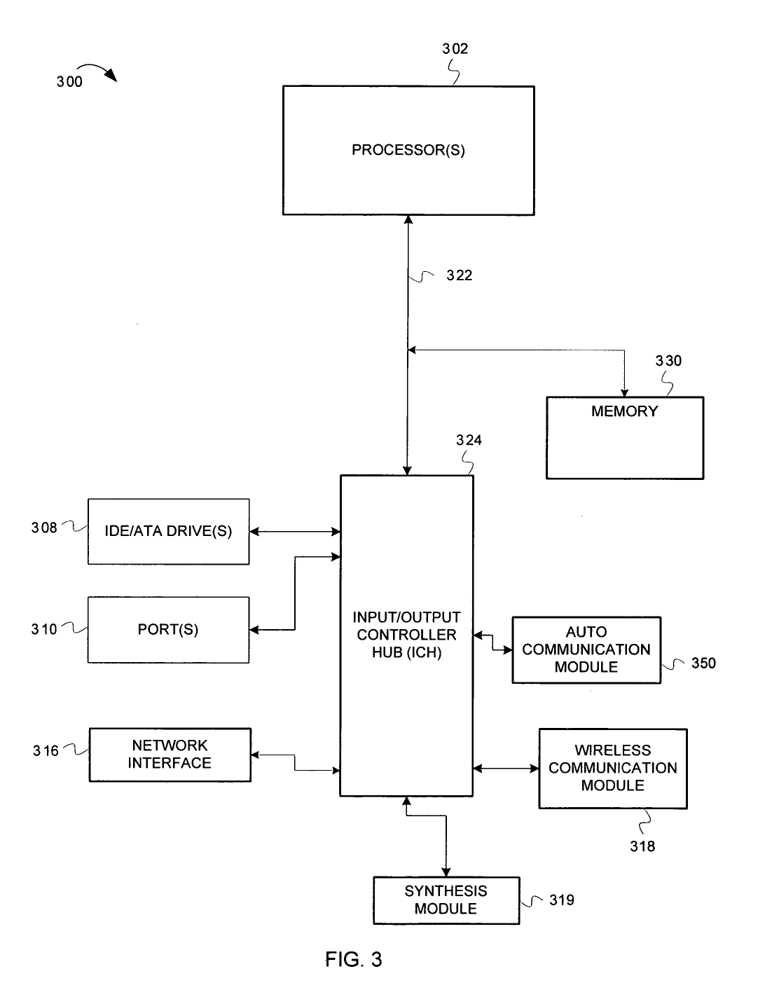

FIG. 3 illustrates parts of a multimedia receiver, according to some embodiments of the invention. A multimedia receiver 300 shown in FIG. 3 may be representative of an architecture within one of the multimedia receivers 104. As shown, the parts of the multimedia receiver 104 may be similar to the parts of the multimedia controller 102. However, the multimedia receiver 104 may not include a display and/or all or some of the user inputs devices (such as the microphone 211, the keyboard 212, the buttons 214, etc.).

The multimedia receiver 300 comprises processor(s) 302. The multimedia receiver 300 also includes a volatile memory 330, processor bus 322, and an Input/Output (I/O) controller hub (ICH) 324. The processor(s) 302, the volatile memory 330, and the ICH 324 are coupled to the processor bus 322. The processor(s) 302 may comprise any suitable processor architecture. The multimedia receiver 300 may comprise one, two, three, or more processors, any of which may execute a set of instructions in accordance with embodiments of the invention. The processor(s) 302 may be different types of processors. For example, a first processor may be a general purpose processor, while a second processor may be a digital signal processor for decoding and encoding audio data, video data, etc.

The memory 330 may be representative of volatile and/or non-volatile memory that stores data and/or instructions, and may comprise any suitable memory, such as a dynamic random access memory (DRAM), etc. The nonvolatile memory may be Static Random Access Memory (SRAM), flash memory, etc. The nonvolatile memory may also be Programmable ROM (PROM), Erasable PROM (EPROM), Electrically Erasable PROM (EEPROM), etc.

The multimedia receiver 300 may include a wireless communication module 318, a synthesis module 319 and an auto communication module 350. The wireless communication module 318, the synthesis module 319 and the auto communication module 350 may be representative of hardware, firmware or a combination thereof. The wireless communication module 318, the synthesis module 319 and the auto communication module 350 may be software instructions that reside in the memory 230 and/or one of the IDE/ATA drives 208, which may be executed by the processor(s) 202. The operations of the wireless communication module 318, the synthesis module 319 and the auto communication module 350 are described in more detail below.

The ICH 324 provides an interface to I/O devices or peripheral components for the multimedia receiver 300. The ICH 324 may comprise any suitable interface controller to provide for any suitable communication link to the processor(s) 302, the memory 330 and/or to any suitable device or component in communication with the ICH 324. In some embodiments, the ICH 324 provides suitable arbitration and buffering for each interface.

For some embodiments of the invention, the ICH 324 provides an interface to a secondary storage 308 (which may be any type of nonvolatile data storage), such as a hard disk drive (HDD) or compact disc read only memory (CD ROM) drive, or to suitable universal serial bus (USB) devices through one or more USB ports. The secondary storage 308 may be read only, read/write, etc.

For some embodiments, the ICH 324 also provides a network interface 320 though which the multimedia receiver 300 may communicate with other computers and/or devices. The multimedia receiver 300 may also include a wireless communication module 318. The wireless communication module 318 may be hardware, software, firmware or a combination thereof to configure data communication according to one or more wireless protocols through the network interface 316. The ICH 324 may provide an interface to any number of ports 310. The ports 310 may be used to provide different input/output. For example, one or more ports 310 may be coupled to speakers for audio output.

In some embodiments, the multimedia receiver 300 includes a machine-readable medium that stores a set of instructions (e.g., software) embodying any one, or all, of the methodologies for the operations described herein. Furthermore, software may reside, completely or at least partially, within memory unit 330 and/or within the processor(s) 302.

### Example Electronic Device Detected in a Zone

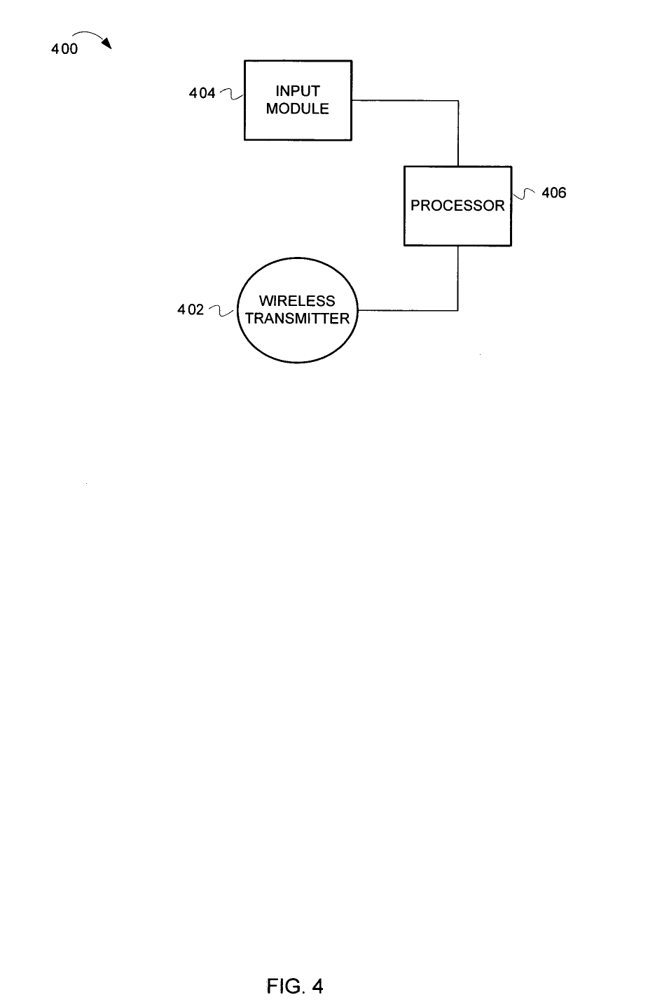

FIG. 4 illustrates parts of an electronic device to be detected in a zone, according to some embodiments of the invention. An electronic device 400 shown in FIG. 4 may be representative of an architecture within any of a number of different electronic devices. The electronic device 400 may be representative of parts of the multimedia receiver 104. Accordingly, some of the parts described for the electronic device 400 may be incorporated into the architecture in the multimedia receiver 300 (shown in FIG. 3). The electronic device 400 may also be representative of parts of other electronic devices that may or may not be coupled to one of the multimedia receivers 104. For example, the electronic device 400 may be representative of parts of a Compact Disc (CD) player/recorder, a Digital Video Disk (DVD) player/recorder, a set top box, a security system, a thermostat, a television, etc.

The electronic device 400 comprises a processor 406. The electronic device 400 also includes a wireless transmitter 402 and an input module 404, which are coupled to the processor 406. Although not shown, the electronic device 400 may include other components (such as a volatile memory, a nonvolatile memory, a display, different input components, etc.). The wireless transmitter 402 may output different types of wireless communication. In some embodiments, the wireless transmitter 402 outputs a wireless communication that cannot be transmitted through an opaque material (such as an infrared signal). Accordingly, the wireless communication may not be transmitted through solids walls of a house, an office, etc. The input module 404 may be representative of hardware, software, firmware or a combination thereof. In some embodiments, the input module 404 receives wireless control signals (such as those from the multimedia controller 102). The processor 406 may control the input module 404 and the wireless transmitter 402. The operations of the electronic device 400 are described in more detail below.

### Operations for Multimodal Processing

This section provides a description of operations for multimodal processing, according to some embodiments of the invention. In certain embodiments, the operations are performed by instructions residing on machine-readable media (e.g., software), while in other embodiments, the methods are performed by hardware or other logic (e.g., digital logic).

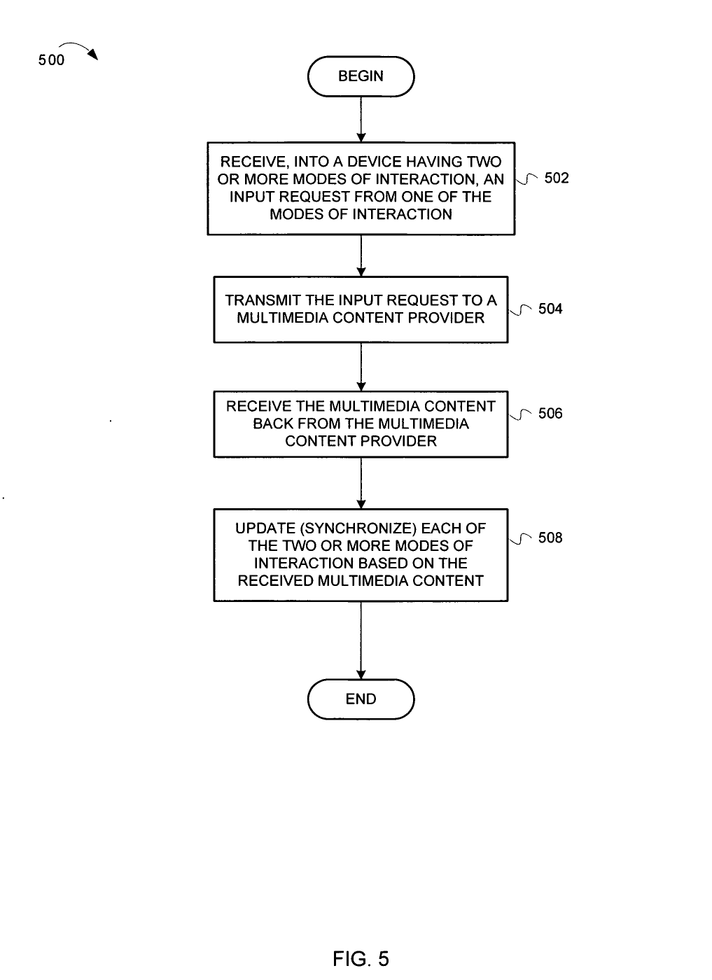

FIG. 5 illustrates a flow diagram for multimodal processing, according to some embodiments of the invention. FIG. 5 illustrates operations that may be executed by the multimedia controller 102. The flow diagram 500 commences at block 502.

At block 502, an input request for multimedia content is received into a device, having two or more modes of interaction, from one of the two or more modes. With reference to FIG. 1, the multimedia controller 102 receives the input request for multimedia content. For example, the multimedia controller 102 may receive input from a voice of a user using the microphone 211. Other modes of interaction may include the keyboard 212, the buttons 214, etc. (as described above). The flow continues at block 504.

At block 504, the input request is transmitted to the multimedia content provider. With reference to FIG. 1, the multimedia controller 102 may transmit the input request to the multimedia content provider 110. With reference to FIG. 2, the wireless communication module 218 may receive the input and output the input request to the multimedia content provider 110 through the network interface 216. The flow continues at block 506.

At block 506, the multimedia content is received back from the multimedia content provider (in response to the input request). With reference to FIG. 1, the multimedia controller 102 may receive the multimedia content back from the multimedia content provider 110. With reference to FIG. 2, the wireless communication module 218 may receive the multimedia content through the network interface 216. The flow continues at block 508.

At block 508, each of the two or more modes of interaction for the multimedia controller is updated (synthesized) based on the received multimedia content. With reference to FIG. 2, the wireless communication module 218 may update (synthesize) each of the modes of interaction. The wireless communication module 218 may update the display device 206, the microphone 211, the keyboard 212, the buttons 214, etc. For example, if the input request was for a list of all of songs for a given artist, the display 206 may be updated to show this list. The display device 206 may be a touch screen. Accordingly, soft buttons on the display device 206 may be updated to select one or more songs from the list. Moreover, the keyboard 212 and the buttons 214 are updated such that input from such inputs or the microphone 211 may be used for the next input for the multimedia controller 102. For example, even though the microphone 211 was used for the input request, the buttons 214 may be mapped to allow for the selection of the songs from the returned list. In some embodiments, some but not all of the modes of interaction are updated based on the result of the input request. In some embodiments, a mapping among different modes of interaction may be used to determine which modes of interaction should be updated based on the input request. The mapping may be stored in a machine readable medium in the multimedia content provider 110, the multimedia controller 102, etc. Accordingly, as described, different modes of interaction for a same device are updated, regardless of which mode was used for a given input request. Moreover, at any point in the operation, any one of multiple modes of interaction may be used. For example, the voice input may be used for a broad search, while the buttons may be used to further refine the search. The operations of the flow diagram 500 are complete.

### Synthesis of Multiple Multimedia Output

This section provides a description of a synthesis of multiple multimedia output, according to some embodiments of the invention. In particular, some embodiments synthesize different multimedia content to be output. The multimedia content may be of different priority. In some embodiments, music may be classified as low priority, while other types of audio (such as requests for stock quotes, news of the day, alarms, etc.) may be classified as high priority. With reference to FIG. 1, the synthesized multimedia content may be output to the multimedia controller 102 and/or the multimedia receivers 104. In certain embodiments, the operations are performed by instructions residing on machine-readable media (e.g., software), while in other embodiments, the methods are performed by hardware or other logic (e.g., digital logic).

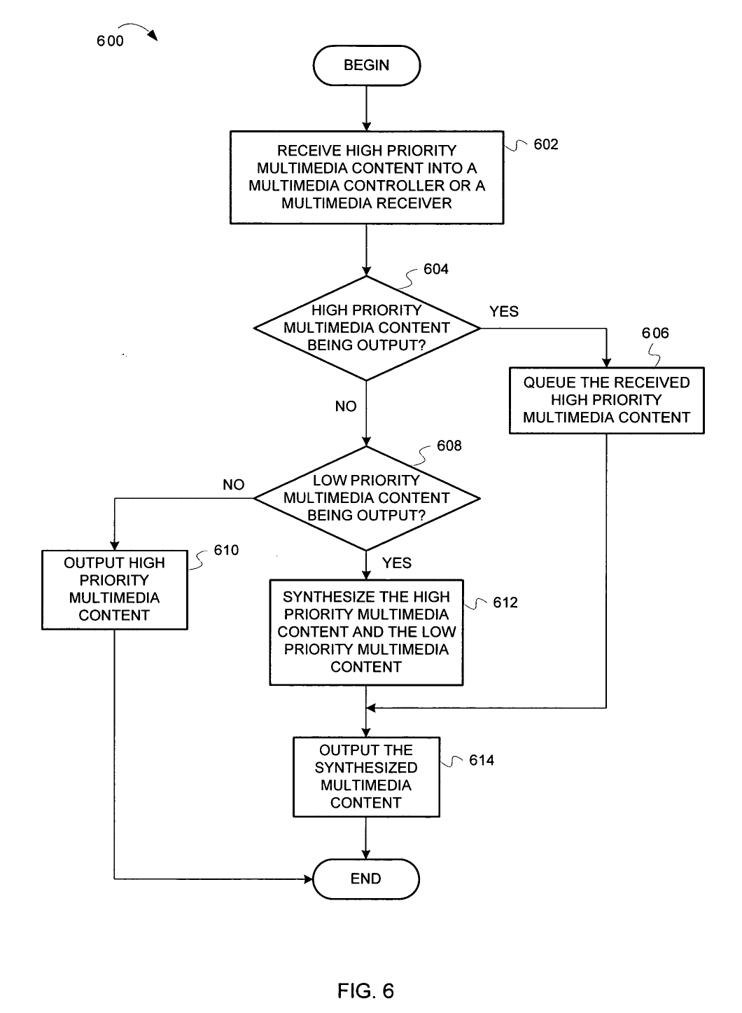

FIG. 6 illustrates a flow diagram for synthesis of multiple multimedia output, according to some embodiments of the invention. FIG. 6 illustrates operations that may be executed by the multimedia controller 102 or by the multimedia receiver 104. The flow diagram 600 commences at block 602.

At block 602, high priority multimedia content is received into a multimedia controller or a multimedia receiver. With reference to FIG. 1, the multimedia controller 102 or the multimedia receiver 104 may receive the high priority multimedia content. For example, a user (using one of the modes of the multimedia controller 102) may request that a stock quote be output to one of the multimedia receivers 104. The flow continues at block 604.

At block 604, a determination is made of whether high priority multimedia content is currently being output to the multimedia controller or the multimedia receiver. With reference to FIG. 2 and assuming that the output is to the multimedia controller, the synthesis module 219 (for the multimedia controller 200) may make this determination. With reference to FIG. 3 and assuming that the output is to one of the multimedia receivers, the synthesis module 319 (for the multimedia receiver 300) may make this determination. If there is high priority multimedia content being output, the flow continues at this block 606. Otherwise, the flow continues at block 608 (which is described in more detail below).

At block 606, the received high priority multimedia content is queued. With reference to FIG. 2 and assuming that the output is to the multimedia controller, the synthesis module 219 (for the multimedia controller 200) may queue the received high priority multimedia content. With reference to FIG. 3 and assuming that the output is to the multimedia receiver, the synthesis module 319 (for the multimedia receiver 300) may queue the received high priority multimedia content. The synthesis module 219/319 may queue the content into a local machine readable medium (such as the memory unit 230/330, one of the IDE/ATA drives 208/308, etc.). The flow continues at block 614 (which is described in more detail below).

At block 608, a determination is made of whether low priority multimedia content is being output to the multimedia controller or the multimedia receiver. With reference to FIG. 2 and assuming that the output is to the multimedia controller, the synthesis module 219 (for the multimedia controller 200) may make this determination. With reference to FIG. 3 and assuming that the output is to one of the multimedia receivers, the synthesis module 319 (for the multimedia receiver 300) may make this determination. For example, the multimedia controller 102 or the multimedia receiver 104 may be outputting music. If there is not low priority multimedia content being output, the flow continues at this block 610. Otherwise, the flow continues at block 612 (which is described in more detail below).

At block 610, the received high priority multimedia content is output. With reference to FIG. 2 and assuming that the output is to the multimedia controller, the synthesis module 219 (for the multimedia controller 200) may cause the content to be output through speaker(s) coupled to the port(s) 210. With reference to FIG. 3 and assuming that the output is to one of the multimedia receivers, the synthesis module 319 (for the multimedia receiver 300) may cause the content to be output through speaker(s) coupled to the port(s) 310. Accordingly, synthesis of multiple multimedia content is not needed. The operations of the flow diagram 600 are complete.

At block 612, the high priority multimedia content and the low priority multimedia content are synthesized. With reference to FIG. 2 and assuming that the output is to the multimedia controller, the synthesis module 219 (for the multimedia controller 200) may synthesize the content. With reference to FIG. 3 and assuming that the output is to one of the multimedia receivers, the synthesis module 319 (for the multimedia receiver 300) may synthesize the content. The synthesis module 219/319 may use different types of mixer operations for synthesizing the content. In some embodiments, the volume of the low priority multimedia content is lower relative to the volume of the high priority multimedia content. In some embodiments, the low priority content could be paused while the high priority content is being output. Subsequently, the high priority content may be resumed where it was paused. Alternatively, the low priority content may be resumed such that the output continues assuming that the content had continued to be played. For example, if the high priority content outputs for 30 seconds, after completion of the high priority content, the low priority content is moved forward 30 seconds and then continues output. Such an operation may be used if the low priority content is being distributed to multiple zones so that such content may remain in sync. The flow continues at block 614.

At block 614, the synthesized multimedia content is output. With reference to FIG. 2 and assuming that the output is to the multimedia controller, the synthesis module 219 (for the multimedia controller 200) may cause the synthesized multimedia content to be output through speaker(s) coupled to the port(s) 210. With reference to FIG. 3 and assuming that the output is to one of the multimedia receivers, the synthesis module 319 (for the multimedia receiver 300) may cause the synthesized multimedia content to be output through speaker(s) coupled to the port(s) 310. The operations of the flow diagram 600 are complete.

### Wireless Configuration of Unconfigured Electronic Devices

This section provides a description of operations for a wireless configuration of unconfigured electronic devices, according to some embodiments of the invention. In certain embodiments, the operations are performed by instructions residing on machine-readable media (e.g., software), while in other embodiments, the methods are performed by hardware or other logic (e.g., digital logic).

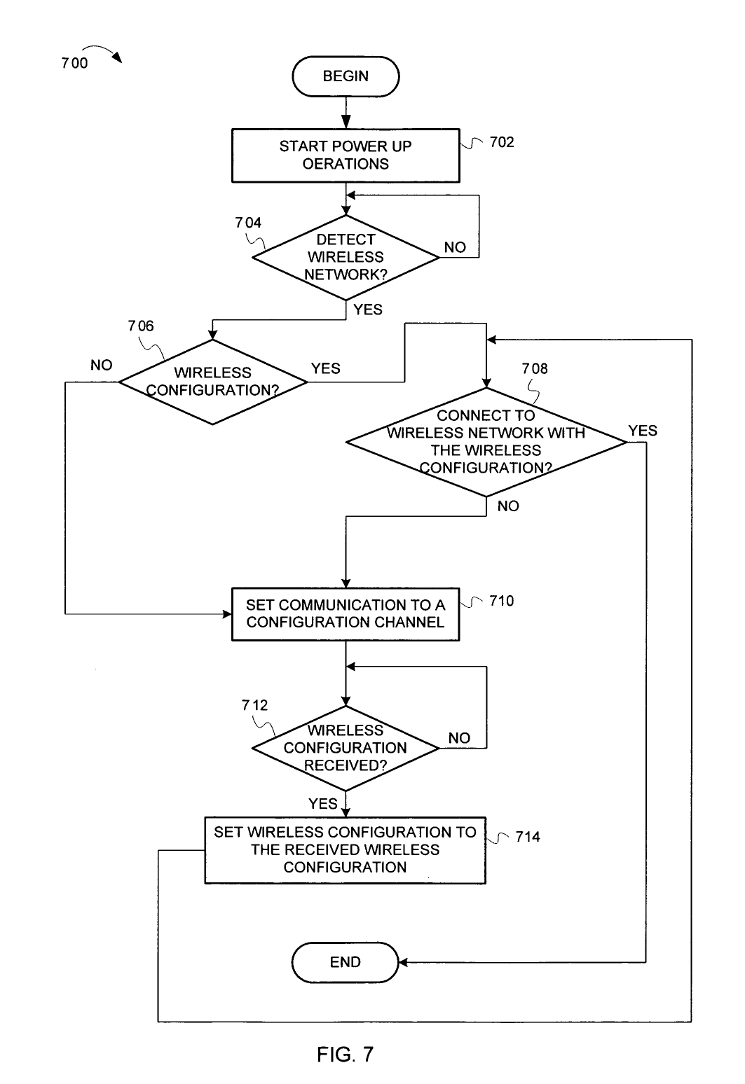

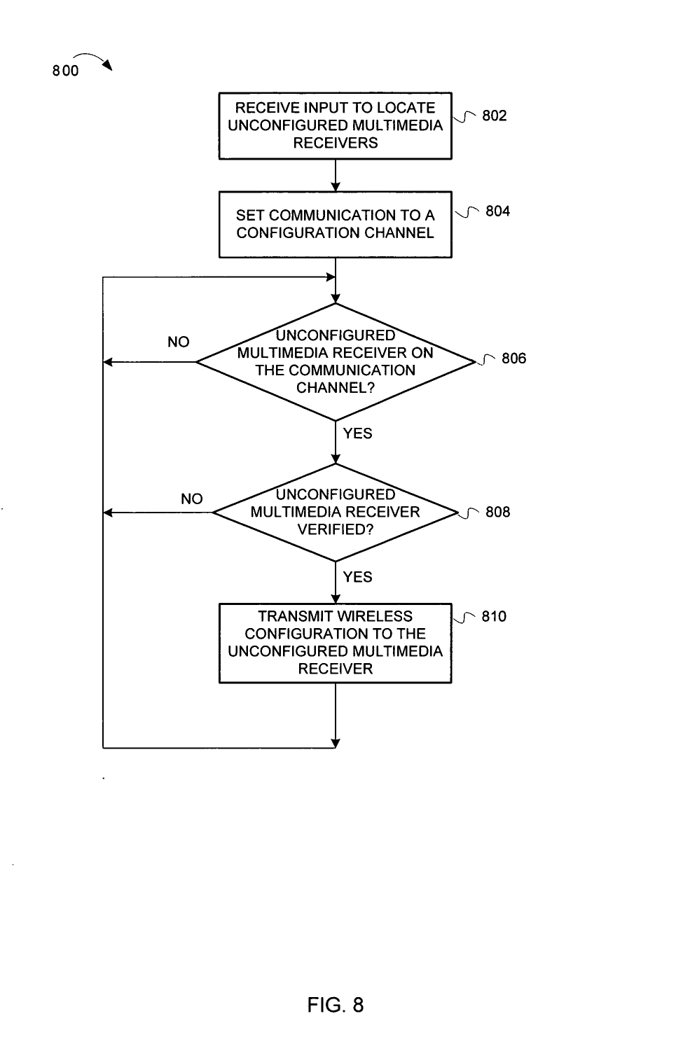

In this section, FIGS. 7-8 are discussed. In particular, FIGS. 7-8 describe operations for wireless configuration, according to some embodiments of the invention. The operations enable a wireless device to be configured to connect to a wireless network (for which the device is not configured to connect to). FIG. 7 describes operations of a device to be configured for a wireless network. FIG. 8 describes operations of a device to locate and configure devices for a wireless network. While described in reference to the multimedia controller 102 configuring multimedia receivers 104, such operations may be performed by and to any type of devices. For example, other devices (such as a desktop computer, notebook computer, etc.) may perform the configuration operations. Furthermore, other devices to be configured may include different electronic devices communicating on a wireless network (e.g., notebook computers, set top boxes, etc.). This description proceeds with a discussion of FIG. 7.

FIG. 7 illustrates a flow diagram of operations of a device to be configured for a wireless network, according to some embodiments of the invention. FIG. 7 illustrates operations that may be executed by the multimedia controller 102. The flow diagram 700 commences at block 702.

At block 702, power up operations are started. With reference to FIG. 3, the multimedia receiver 104 may start power up operations after power is supplied thereto. Power up operations may also be started after the multimedia receiver 104 is reset. The flow continues at block 704.

At block 704, a determination is made of whether a wireless network is detected. With reference to FIG. 3, the auto communication module 350 may make this determination. The auto communication module 350 may receive a result back from the wireless communication module 318 that indicates whether one or more wireless communication devices (such as a wireless router) is transmitting wireless communication to allow for connection to the wireless network. If a wireless network is not detected, the flow continues at this block 704. In other words, the auto communication module 350 waits until there is a detection of a wireless network. Otherwise, the flow continues at block 706.

At block 706, a determination is made of whether the multimedia receiver 104 has a wireless configuration. With reference to FIG. 3, the auto communication module 350 may make this determination. This wireless configuration may be stored in a nonvolatile memory (such as the memory 330) within the multimedia receiver 104, within a memory in the wireless configuration module 318, etc. Accordingly, the auto communication module 350 determines whether such configuration data is stored therein. If the wireless configuration is not found, the flow continues at block 710 (which is described in more detail below). Otherwise, the flow continues at block 708.

At block 708, a determination is made of whether connection may be made with the detected wireless network with the wireless configuration. With reference to FIG. 3, the auto communication module 350 may make this determination. The wireless communication module 318 may attempt to connect to the wireless network using the wireless configuration (through the network interface 316). The auto communication module 350 may receive a result from the wireless communication module 318 whether such connection was made. If the connection is made, the operations of the flow diagram 700 are complete. Otherwise, the flow continues at block 710.

At block 710, the communication for the multimedia receiver 104 is set to a configuration channel. With reference to FIG. 3, the auto communication module 350 may perform this operation. Wireless communications may be performed on one to a number of channels. In some embodiments, the system 100 is configured such that one or more channels of wireless communication are designated as configuration channels. Accordingly, the channels may be partitioned into configuration and non-configuration channels. The configuration channels may be used to communicate configuration data for wireless devices to connect to the wireless network. The non-configuration channels may be used for substantive communications that is not related to the configuration of the wireless devices. For example, as described above, the non-configuration channels may be used to communicate different types of requests and transmission of multimedia content. The flow continues at block 712.

At block 712, a determination is made of whether wireless configuration is received on the configuration channel. With reference to FIG. 3, the auto communication module 350 may make this determination. The auto communication module 350 may query the wireless communication module 350 if such communication is received. As described below, the wireless configuration may be received from the multimedia controller 102. In some embodiments, the wireless configuration may include an identification of the wireless network. In some embodiments, the wireless network may be secured using some type of encryption. Therefore, the wireless configuration may include an encryption key used for the secured communication on the wireless network. In some embodiments, the wireless configuration may include both the identification of the wireless network and the encryption key. If the wireless configuration is not received, the flow remains at this block 712 (waiting for the wireless configuration). Otherwise, the flow continues at block 714.

At block 714, the wireless configuration for the multimedia receiver 104 is set in accordance with the wireless configuration data received. With reference to FIG. 3, the auto communication module 350 may perform this operation. The auto communication module 350 may store this data within a memory within the multimedia receiver 104 (which may be one of a number of locations as described above). The flow continues at block 708, wherein connection to the wireless network is attempted using the updated wireless configuration. In some embodiments, the multimedia receiver 104 may be reset prior to attempting the connection. Accordingly, the operations may continue at block 702.

The operations by the multimedia controller 102 for configuring the multimedia receiver 104 for a wireless network are now described. In particular, FIG. 8 illustrates a flow diagram of operations of a device to configure other devices for a wireless network, according to some embodiments of the invention. The flow diagram 800 commences at block 802.

At block 802, an input to locate unconfigured multimedia receivers is received. With reference to FIG. 2, the configuration module 250 may receive this input. In some embodiments, a user may input such a request into the multimedia controller 102. For example, if the user adds a new multimedia receiver 104 to the system 100, the user may input this request. Alternatively or in addition, periodically a timer within the multimedia controller 200 may cause such an input therein. The flow continues at block 804.

At block 804, the communication for the multimedia controller 102 is set to a configuration channel. With reference to FIG. 2, the configuration module 250 may perform this operation. As described above, in some embodiments, the communication channels may include configuration and non-configuration. The flow continues at block 806.

At block 806, a determination is made of whether there are unconfigured multimedia receivers attempting to receive wireless configuration on the configuration channel. With reference to FIG. 2, the configuration module 250 may make this determination. The configuration module 250 may query the wireless configuration module 218 whether any multimedia receivers 104 are communicating on the configuration channel. For example, the multimedia receivers 104 may send a communication that indicates that wireless configuration is needed for the wireless network. If there are no multimedia receivers 104 attempting to receive wireless configuration data on the configuration channel, the flow continues at this block 806, where this configuration channel is continued to be checked for unconfigured multimedia receivers. If there is a multimedia receiver attempting to receive wireless configuration data, the flow continues at block 808.

At block 808, the unconfigured multimedia receiver attempting to receive wireless configuration is verified. With reference to FIG. 2, the configuration module 250 may perform this verification. In some embodiments, the configuration module 250 may output an indication on the display 206 that there is an unconfigured multimedia receiver. In some embodiments, a user may input some type of identification of the unconfigured multimedia receiver. For example, a user may input some or all of the network address (such as the Ethernet address) for the unconfigured multimedia receiver. The configuration module 250 may verify this address using a list of valid addresses stored in a machine readable media in the multimedia controller 200 or the multimedia content provider 110. Accordingly, such verification precludes a rogue wireless network device from receiving the wireless configuration and connecting to the wireless network. If the unconfigured multimedia receiver is not verified, the flow continues at this block 806, where this is configuration channel is continued to be checked for unconfigured multimedia receivers. Otherwise, the flow continues at block 810.

At block 810, the wireless configuration is transmitted to the unconfigured multimedia receiver. With reference to FIG. 2, the configuration module 250 may perform this operation. The configuration module 250 may transmit the identification of the wireless network, the encryption key for secured communications on the wireless network, etc. The flow continues at block 806. Accordingly, the multimedia controller 102 continues to check for unconfigured multimedia receivers. The flow diagram 800 may be aborted at any point by a user that inputs a request to return to a non-configuration mode (to communicate on a non-configuration channel). For example, if the user wants to use the multimedia controller 102 to control the distribution of the multimedia content (as described above), the user may change the multimedia controller 102 out from this configuration mode.

While described relative to a user of the multimedia controller 102 involved in some of the operations, embodiments are not so limited. For example, in some embodiments, one of the multimedia receivers 104 may perform the operations of the flow diagram 800. Accordingly, the multimedia receiver 104 may be configured to periodically check the configuration channel to determine if any unconfigured multimedia receivers are waiting for wireless configuration. The multimedia receiver 104 may also be configured to include a list of valid addresses associated with the unconfigured multimedia receivers 104 used for the verification.

### Detection of Devices in a Zone

This section provides a description of a configuration for detection of devices in a zone, according to some embodiments of the invention. In certain embodiments, the operations are performed by instructions residing on machine-readable media (e.g., software), while in other embodiments, the methods are performed by hardware or other logic (e.g., digital logic).

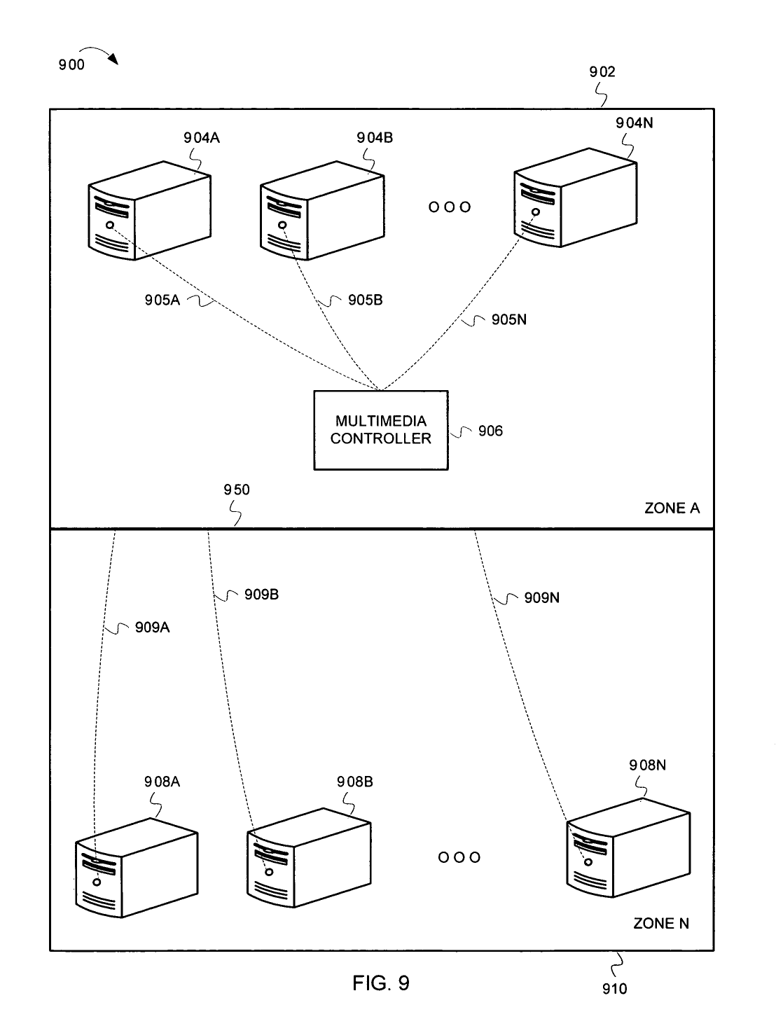

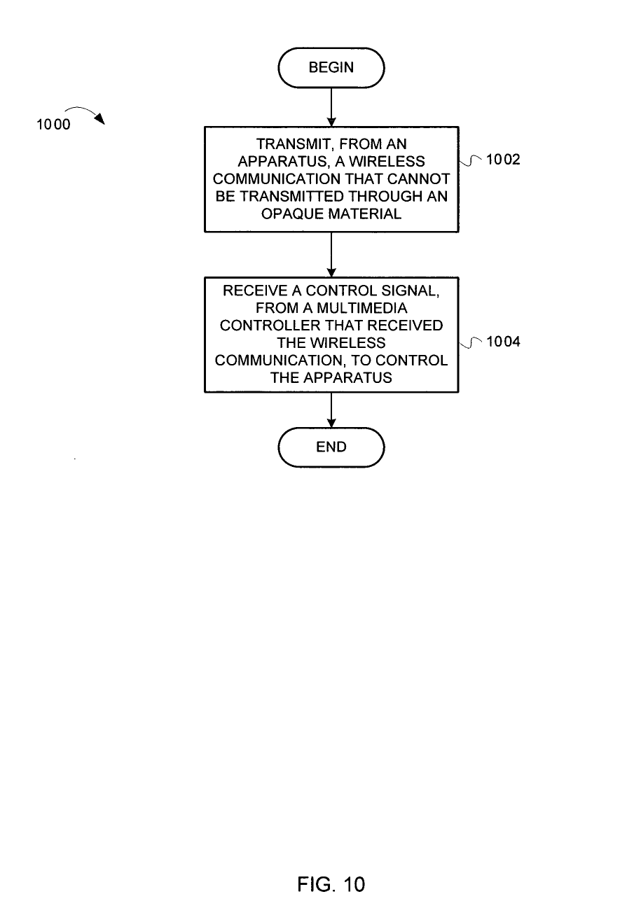

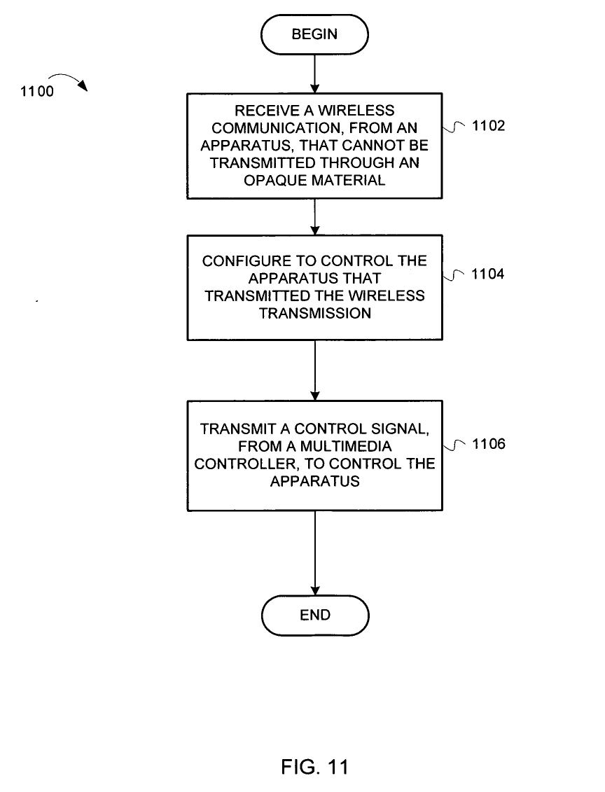

In this section, FIGS. 9-11 are discussed. In particular, FIG. 9 illustrates a system that includes detection of devices in a zone, according to some embodiments of the invention. FIGS. 10-11 describe operations for detection of devices in a zone, according to some embodiments of the invention. Specifically, FIG. 10 describes operations of a device to be detected and subsequently controlled by a wireless remote control. FIG. 11 describes operations of a wireless remote control for detection and control of electronic devices. While described in reference to the multimedia controller 102 detecting and controlling of electronic devices, such operations may be performed by any type of wireless remote controls. This description proceeds with a discussion of FIG. 9.

FIG. 9 is a block diagram illustrating a system for detecting electronic devices in a zone, according to some embodiments of the invention. A system 900 includes a multimedia controller 906, a number of electronic devices 904A-904N in a zone A 902 and a number of electronic devices 908A-908N in a zone N 910. The multimedia controller 906 may be representative of the multimedia controller 102 or any other wireless remote control. The electronic devices 904 may be representative of the multimedia receivers 104, a CD player/recorder, a DVD player/recorder, a set top box, a security system, a thermostat, a television, etc. A more detailed block diagram of one of the electronic devices 904 is illustrated in FIG. 4 (which is described above).

The zone A 902 and the zone N 910 may be representative of different parts of a system. For example, in some embodiments, the zone A 902 and the zone N 910 may be different rooms in a home, office, etc. The zone A 902 and the zone N 910 are separated along a separation 950. In some embodiments, the separation 950 may be an opaque material (such as a solid wall in a home, office, etc.).

The electronic devices 904A-904N transmit wireless transmissions 905A-905N. The electronic devices 908A-908N transmit wireless transmissions 909A-909N. The wireless transmissions 905A-905N and the wireless transmissions 909A-909N may be different types of wireless communications. The wireless transmissions 905A-905N and the wireless transmissions 909A-909N may or may not be of the same type. In some embodiments, the wireless transmissions 905A-905N cannot be transmitted through an opaque material (such as a wall). For example, the wireless transmissions 905A-905N may be infrared signals.

The multimedia controller 906 is located in the zone A and is able to detect the wireless transmissions 905A-905N. After receiving the wireless transmissions 905A-905N, the multimedia controller 906 may be configured to control the electronic devices 904A-904N. In some embodiments, the multimedia controller 906 may have such configuration data stored within a machine-readable medium therein. Alternatively or in addition, the multimedia controller 906 may download such configuration data from a multimedia service provider. Examples of the configuration data may include the type of device, types of controls for such a device, the standard for communication for such device, etc.

Also, because in some embodiments the wireless transmissions 909A-909N cannot be transmitted through an opaque material, the multimedia controller 906 is not able to detect such transmissions. Therefore, the multimedia controller 906 is not configured to control the electronic devices 908A-908N. Accordingly, as described, in some embodiments, as a user moves the multimedia controller 906 through different zones, the multimedia controller 906 may be reconfigured to control the electronic devices for a given zone. In other words, while the multimedia controller 906 is located in zone A, the multimedia controller 906 is configured to control the electronic devices 904A-904N. While the multimedia controller 906 is located in zone N, the multimedia controller 906 is configured to control the electronic devices 908A-908N.

The operations of the electronic devices 904A-904N for detection in a zone are now described. In particular, FIG. 10 illustrates a flow diagram of operations of an electronic device to be detected and subsequently controlled by a multimedia controller, according to some embodiments of the invention. The flow diagram 1000 is described in reference to FIG. 9 and the electronic device 400 (shown in FIG. 4). The flow diagram 1000 commences at block 1002.

At block 1002, a wireless transmission, which cannot be transmitted through an opaque material, is transmitted from an apparatus. With reference to FIG. 4, the apparatus may be the electronic device 400. The processor 406 may cause the wireless transmitter 402 to output the wireless transmission. In some embodiments, the wireless transmission may be an infrared signal. As described, the wireless transmission may be such that it cannot be transmitted through an opaque material, such as a wall in a home or office. In some embodiments, the zones in the system (as shown in FIG. 1) are separated substantially by opaque material. Therefore, the wireless transmission for the electronic device is limited to the zone in which the device is located. The wireless transmission may include an identification of the electronic device 400. For example, the identification may include the type of device, the make and model number, etc.

In some embodiments, the wireless transmitter 402 may output the wireless transmission while power is supplied to the electronic device 400. Alternatively, the wireless transmitter 402 may output the wireless transmission until a stop transmission indication is received from the multimedia controller 906. For example, the multimedia controller 906 may output such a signal after receiving the wireless transmission and being configured to control the device. In some embodiments, the processor 406 may cause the wireless transmitter 402 to commence the outputting of the wireless transmission after motion is detected in the zone. For example, if a user with the multimedia controller 906 walks into the zone, the wireless transmission may commence. The flow continues at block 1004.

At block 1004, a control signal is received from a multimedia controller that received the wireless communication to control the apparatus. With reference to FIG. 4, the input module 404 may receive the control signal from the multimedia controller 906. The control signal may be to control different operations of the electronic device 400. For example, the control signal may be related to adjusting the volume, channel, input source, etc. As described above, in some embodiments, the control signal may cause the wireless transmitter 402 to cease the outputting of the wireless transmission. Accordingly, the multimedia controller 906 may output different control signals for controlling the electronic device. Therefore, the multimedia controller 906 may receive the wireless transmission from the different electronic devices in a given zone where the multimedia controller 906 is located. Also, in some embodiments, the multimedia controller 906 does not receive the wireless transmission from electronic devices in the other zones. Accordingly, the multimedia controller 906 is not configured to control the devices in other zones. The operations of the flow diagram 1000 are complete.

The operations of the multimedia controller 906 for detecting electronic devices in a zone are now described. In particular, FIG. 11 illustrates a flow diagram of operations of a multimedia controller to detect and subsequently control electronic devices in a zone, according to some embodiments of the invention. The flow diagram 1100 is described in reference to FIG. 9 and the multimedia controller 200 (shown in FIG. 2). The flow diagram 1100 commences at block 1102.

At block 1102, a wireless communication, which cannot be transmitted through an opaque material, is received from an apparatus. With reference to FIG. 2, the wireless communication module 218 (within the multimedia controller 200) may receive the wireless communication through the network interface 216. With reference to FIG. 9, the apparatus may be the electronic devices 904 in zone A (wherein the multimedia controller 906 is located). The flow continues at block 1104.

At block 1104, the multimedia controller is configured to control the apparatus that transmitted the wireless transmission. With reference to FIG. 2, the wireless communication module 218 (in the multimedia controller 200) may configure the multimedia controller 200 to control the apparatus. In some embodiments, the configuration data may be stored within a machine-readable medium in the multimedia controller 218. Alternatively or in addition, with reference to FIG. 1, the multimedia content provider 110 may store such configuration data. Therefore, the wireless communication module 218 may retrieve the configuration data and update a data structure (table, etc.) with the configuration data. For example, based on the identification of the apparatus, the standard of communication, the codes used for controlling the apparatus, etc. is stored in the data structure. To illustrate, the code for adjusting the volume, channels, input sources, power, etc. may be stored in the data structure. The flow continues at block 1106.

At block 1106, a control signal is transmitted from a multimedia controller to control the apparatus. With reference to FIG. 2, the wireless communication module 218 may receive an input from a user to control one of the electronic devices. For example, a display on the multimedia controller 906 may include a list of electronic devices that may be controlled. With reference to FIG. 9, the user may select one of the electronic devices 904 using the multimedia controller 906 within the zone A. Using the multimedia controller 906, the user may control the volume, channel, input source, etc. of the electronic devices 904. The operations of the flow diagram 1100 are complete.

Accordingly, as described, as the multimedia controller 906 is moved from one zone to another, the electronic devices in the zone emit a wireless transmission that is received by the multimedia controller. The multimedia controller may be configured to control and subsequently control such electronic devices.

### Contextual User Output Interface

This section provides a description of displaying a contextual user output interface, according to some embodiments of the invention. The contextual user output interface may include a context for a requested multimedia content. In certain embodiments, the operations are performed by instructions residing on machine-readable media (e.g., software), while in other embodiments, the methods are performed by hardware or other logic (e.g., digital logic).

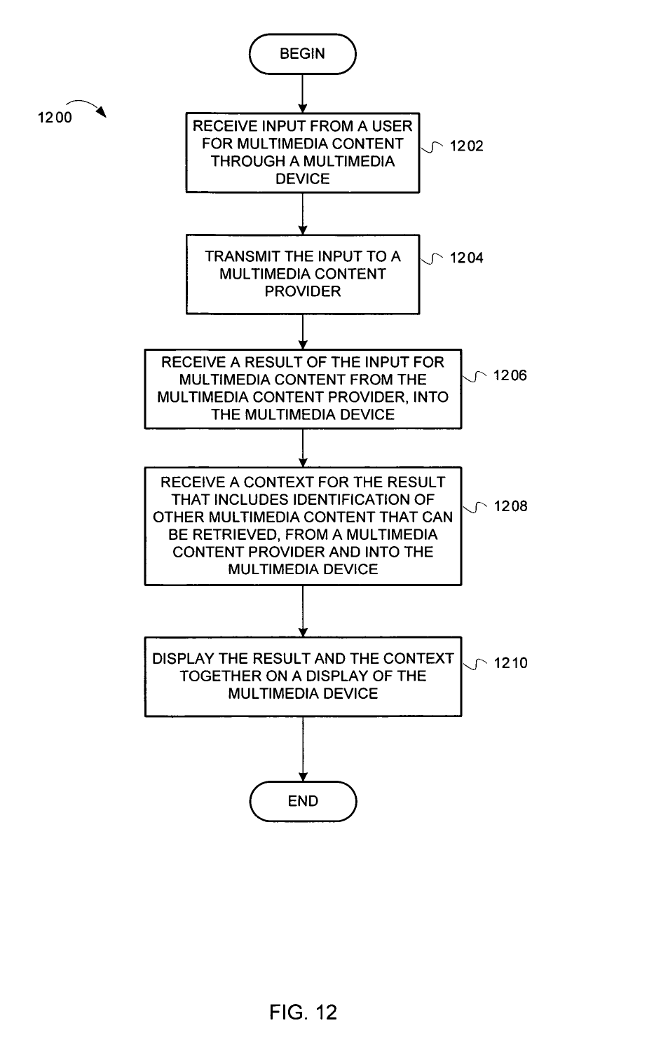

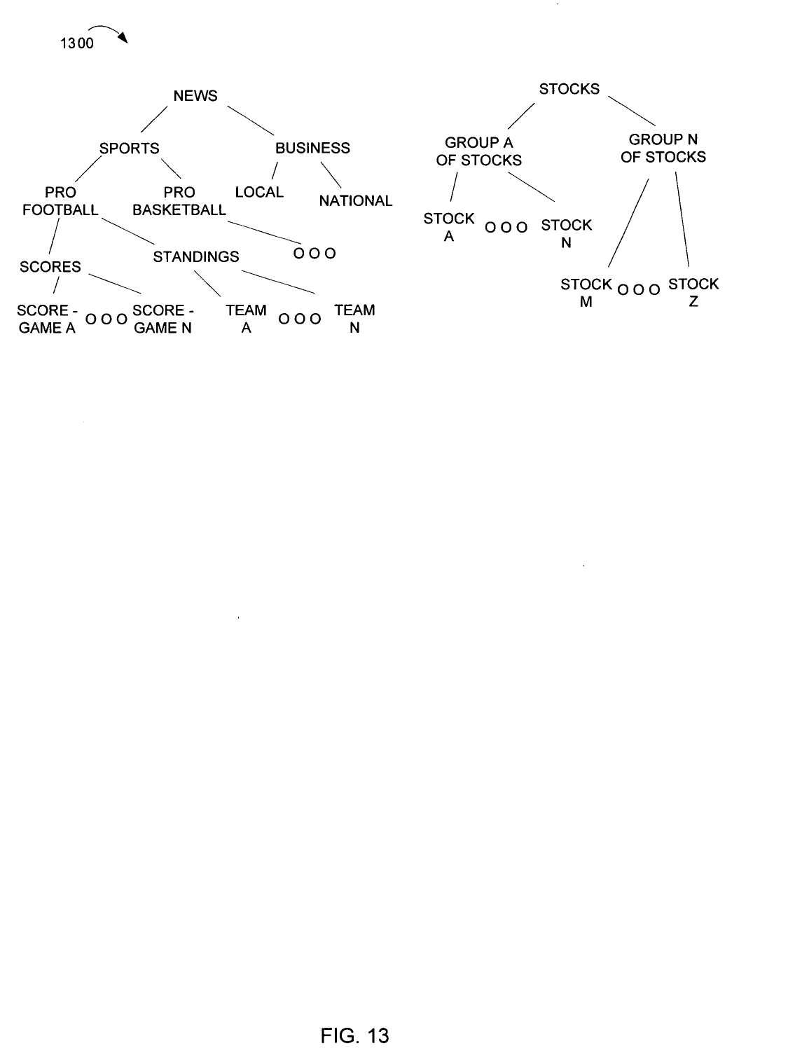

In this section, FIGS. 12-15 are discussed. In particular, FIG. 12 describes operations for displaying a contextual user output interface, according to some embodiments of the invention. FIG. 13 illustrates a mapping of relationships among multimedia content, according to some embodiments of the invention. FIGS. 13-15 illustrates displays having a context for a multimedia content, according to some embodiments of the invention. This description proceeds with a discussion of FIG. 12.

In particular, FIG. 12 illustrates a flow diagram of operations of a multimedia device for displaying of a contextual user output interface, according to some embodiments of the invention. The flow diagram 1200 is described such that the operations are performed by the multimedia controller 200 (shown in FIG. 2). However, such operations may be performed by any type of multimedia device (such as a home computer). The flow diagram 1200 is described in reference to FIG. 1 and the multimedia controller 200 (shown in FIG. 2). The flow diagram 1200 commences at block 1202.

At block 1202, input is received from a user for multimedia content through a multimedia device. With reference to FIG. 2, the multimedia controller 200 receives the input through one mode of multiple modes of interaction. For example, the user may request a showing of all songs for a given artist through a voice input—“Give me a list of all songs performed by artist A.” Additionally, the user may request a particular song, a particular stock, a listing of a given set of stocks, etc. The input may also include the location where the multimedia content is to be distributed. For example, the user may request that a given song be played on multimedia receiver(s) 104 in one or more zones, played on the multimedia controller 102, etc. If the input is for a list that may be further narrowed, the list may be returned back to the multimedia controller 102 to be displayed thereon. The user may input through other modes including the buttons, a keyboard, etc. on the multimedia controller 200. The flow continues at block 1204.

At block 1204, the input for multimedia content is transmitted to a multimedia content provider. With reference to FIG. 2, the wireless communication module 218 transmits this input. With reference to FIG. 1, the input may be transmitted to the multimedia content provider 110. The flow continues at block 1206.

At block 1206, a result of the input for multimedia content is received from the multimedia content provider, into the multimedia device. With reference to FIG. 1, the result is received from the multimedia content provider 110 into the multimedia controller 102. With reference to FIG. 2, the result may be received by the wireless communication module 218. In some embodiments, if the result is to be distributed to one of the multimedia receivers 104, an identification of the result (such as the name of the song, stock, etc.) may also returned to the multimedia controller 102. The flow continues at block 1208.

At block 1208, a context of the result that includes an identification of other multimedia content that can be retrieved is received from the multimedia content provider and into the multimedia received. With reference to FIG. 1, the context is received from the multimedia content provider 110 into the multimedia controller 102. With reference to FIG. 2, the context may be received by the wireless communication module 218. Context may include data around or near the data of the result.

For example, FIG. 13 illustrates a structure for mapping of relationships among multimedia content, according to some embodiments of the invention. The structure of mapping may or may not be representative of the actual storage of the multimedia content. The tree structure 1300 illustrates parts of a tree structure for news and stocks. The child nodes of news include sports and business. The child nodes of sports are professional football and professional basketball. The child nodes of professional football are scores and standings. The child nodes of scores are scores of the individual games (score—game A . . . score—game N). The child nodes of standings are the details for the individual teams (team A . . . team N). Not shown, the child nodes of professional basketball may include child nodes similar that shown for professional football. The child nodes of business include local and national. For stocks, the child nodes include a different groupings of stocks (group A of stocks . . . group N of stocks). The child nodes of group A of stocks include individual stocks (stock A . . . stock N). The child nodes of group N of stocks include individual stocks (stock M . . . stock Z).

In some embodiments, the context for the data result may include an identification of the data one level above and one level below. For example, the context for the data result (scores of professional football) may include the identification of “professional football” and identification of “score—game A” . . . “score—game N”. In some embodiments, the context for the data result may include an identification of the data one level above. Alternatively, the context for the data result may include an identification of the data one level below. In some embodiments, the context may allow the user to pivot in any of a number of directions. For example, a relationship may be mapped to “score of game A” to “team A” (which was playing in game A). Returning to the flow diagram 1200, the flow continues at block 1210.

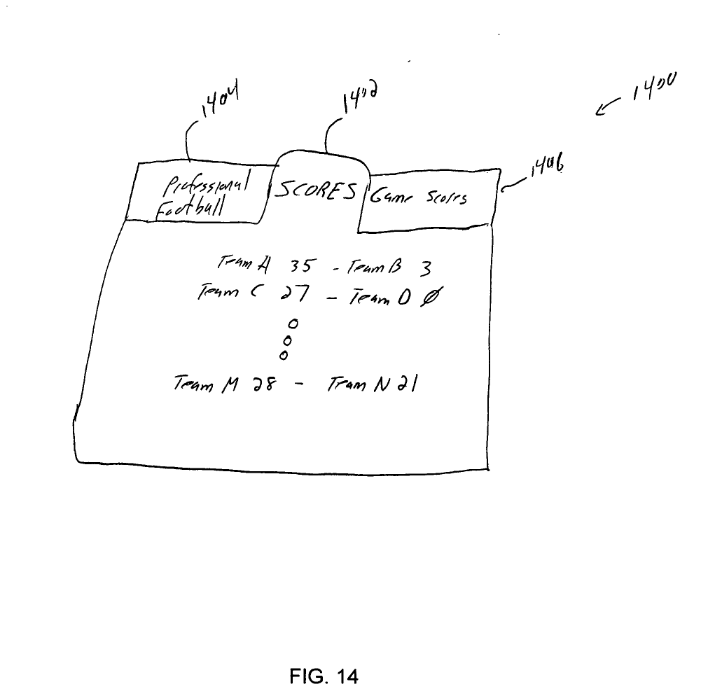

At block 1210, the result and the context are displayed together on a display of the multimedia device. With reference to FIG. 2, the wireless communication module 218 may cause the result and the context to be displayed on the display 206. For example, FIG. 14 illustrates a graphical user interface of a display of a result of scores of professional football and its context, according to some embodiments of the invention. The display 1400 includes a tabbed interface. A tab 1402 displays the result—the scores of the games. For example, the user may input a voice command—“Give me the pro football scores.” The tab 1402 could display the scores for the current week. A tab 1404 and a tab 1406 include a context for the result. The tab 1404 could include an identification of “professional football.” The tab 1406 could include an identification of details of the individual game scores.

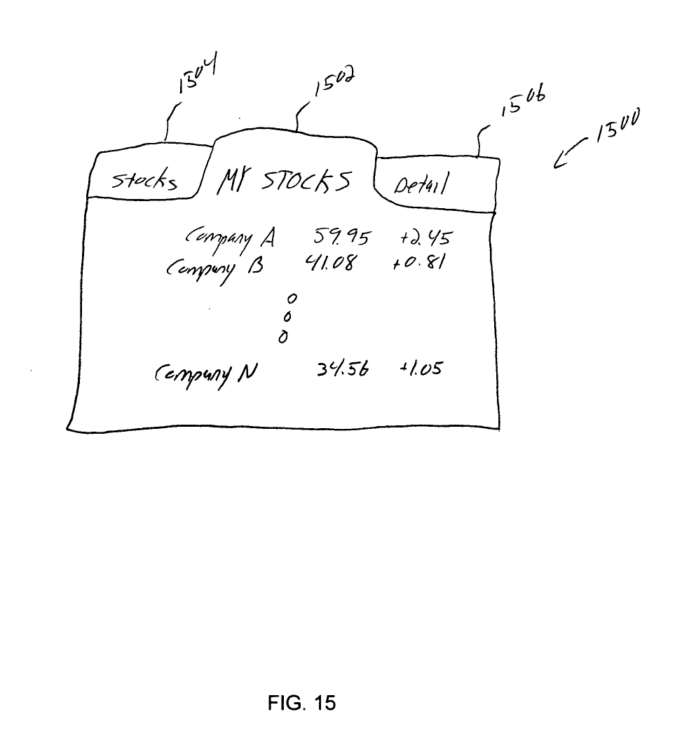

To further illustrate, FIG. 15 illustrates a graphical user interface of a display of a result of a user's stocks and its context, according to some embodiments of the invention. The display 1500 includes a tab interface. A tab 1502 displays the result—“my stocks.” For example, the user may input a voice command—“give me my stocks.” The tab 1502 could display the stocks owned by this particular user. For example, the user may configure the multimedia controller 102 with an identification of the user's stocks. A tab 1504 and a tab 1506 include a context for the result. The tab 1504 could include an identification of “stocks.” The tab 1506 could include an identification of “details” for each of the stocks owned by the user. Therefore, the user of the multimedia controller 102 may select one of the context tabs to retrieve the data associated therewith. While FIGS. 14-15 illustrate a tab interface, embodiments are not so limited. For example, the display may be a map, a table, etc. Moreover, while operations at block 1210 are described as displaying the result and the context, some embodiments may be returned in other output formats (e.g., audio, etc.).

Embodiments described herein may or may not be practiced together. For example, embodiments for the wireless detection may be used with the embodiments for detection of devices in a zone. Moreover, embodiments for synthesizing the output of the multimedia content may be used with embodiments for the multimodal interface.

### General

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the embodiments can include any variety of combinations and/or integrations of the embodiments described herein.

Each claim, as may be amended, constitutes an embodiment of the invention, incorporated by reference into the detailed description. Moreover, in this description, the phrase “exemplary embodiment” means that the embodiment being referred to serves as an example or illustration.

Herein, block diagrams illustrate exemplary embodiments of the invention. Also herein, flow diagrams illustrate operations of the exemplary embodiments of the invention. The operations of the flow diagrams are described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel.

What is claimed is:

1. A method comprising:
receiving, into a device having two or more modes of interaction, an input request for multimedia content from one mode of the two more modes of interaction;
transmitting the input request to a multimedia content provider;
receiving the multimedia content back from the multimedia content provider; and
updating each of the two or more modes of interaction based on the received multimedia content.

2. The method of claim 1, wherein the two or more modes of interaction are selected from a group consisting of a button, a keyboard, a mouse, a stylus, a microphone and a display.

3. The method of claim 1, wherein updating each of the two or more modes of interaction based on the received multimedia content comprises adjusting each of the two or more modes of interaction to allow for a different interaction.

4. The method of claim 1, wherein the multimedia content received is of a high priority and wherein the method further comprises synthesizing the multimedia content received with a multimedia content, which is of a low priority, being currently output from the device.

5. The method of claim 4, wherein synthesizing comprises outputting the multimedia content of the high priority and the multimedia content of the low priority together, wherein the multimedia content of the high priority is output at a higher volume in comparison to the multimedia content of the low priority.

6. The method of claim 1, wherein the multimedia content received comprises a voice output for one of a number of types of multimedia content, wherein the voice output includes a voice that is unique relative to voices of voice output for the other of the number of types of multimedia content.

7. The method of claim 1, wherein receiving the input request comprises recording a voice command, wherein recording comprises a time period prior to an indication to a user that the device is prepared for recording.

8. A machine-readable medium including instructions which when executed by a machine causes the machine to perform operations comprising:
receiving, into a device having two or more modes of interaction, a search request for multimedia content from one mode of the two more modes of interaction;
transmitting the search request to a multimedia content provider;
receiving a result of the search request back from the multimedia content provider;
updating each of the two or more modes of interaction based on the received result of the search request;
receiving, into the device, a more narrow search request for the multimedia content from a second mode of the two or more modes of interaction;
transmitting the more narrow search request to the multimedia content provider;
receiving a result of the more narrow search request back from the multimedia content provider; and
updating each of the two or more modes of interaction based on the received result of the more narrow search request.

9. The machine-readable medium of claim 8, wherein the device comprises a multimedia controller used for distribution of multimedia content across multiple zones.

10. The machine-readable medium of claim 8, wherein the two or more modes of interaction are selected from a group consisting of a button, a keyboard, a mouse, a stylus, a microphone and a display.

11. A machine-readable medium including instructions which when executed by a machine causes the machine to perform operations comprising:
receiving, into a device having multiple modes of interaction, an input request for multimedia content from one mode of the multiple modes of interaction;
transmitting the input request to a multimedia content provider;
receiving the multimedia content and synchronization data back from the multimedia content provider; and
synchronizing the multiple modes of interaction based on the synchronization data.

12. The machine-readable medium of claim 11, wherein the multimedia content received is of a high priority and wherein the method further comprises synthesizing, the multimedia content received with a multimedia content, which is of a low priority, being currently output from the device.

13. The machine-readable medium of claim 12, wherein synthesizing comprises outputting the multimedia content of the high priority and the multimedia content of the low priority together, wherein the multimedia content of the high priority is output at a higher volume in comparison to the multimedia content of the low priority.

14. A method comprising:
receiving, into a device having two or more modes of interaction, a search request for multimedia content from one mode of the two more modes of interaction;
transmitting the search request to a multimedia content provider;
receiving a result of the search request back from the multimedia content provider;
updating each of the two or more modes of interaction based on the received result of the search request;
receiving, into the device, a more narrow search request for the multimedia content from a second mode of the two or more modes of interaction;
transmitting the more narrow search request to the multimedia content provider;
receiving a result of the more narrow search request back from the multimedia content provider; and
updating each of the two or more modes of interaction based on the received result of the more narrow search request.

15. The method of claim 14, wherein the device comprises a multimedia controller used for distribution of multimedia content across multiple zones.

16. The method of claim 14, wherein the two or more modes of interaction are selected from a group consisting of a button, a keyboard, a mouse, a stylus, a microphone and a display.

17. A method comprising:
setting a communication channel of a wireless communication device to a configuration channel in response to a determination that communication cannot be established with a wireless network;
receiving wireless configuration data from a different wireless communication device on the wireless network; and
updating wireless configuration of the wireless communication device to connect to the wireless network based on the received wireless configuration data.

18. The method of claim 17, wherein setting the communication channel of the wireless communication device to the configuration channel in response to the determination that communication cannot be established with the wireless network comprises setting the communication channel of the wireless communication device to the configuration channel in response to the determination that wireless configuration data is not stored in a machine-readable medium of the wireless communication device.

19. The method of claim 17, wherein receiving wireless configuration data from the different wireless communication device comprises receiving an identification of the wireless network and an encryption key for communication on the wireless network.

20. A method comprising:
receiving input from a user to locate one or more digital music receivers not configured to access a wireless network;
changing communication on the wireless network from a non-configuration channel to a configuration channel; and
establishing communication with the one or more digital music receivers using the configuration channel; and
transmitting wireless configuration data to the one or more digital music receivers, after the user has input verification of the one or more digital music receivers.

21. The method of claim 20, wherein transmitting the wireless configuration data comprises transmitting an identification of the wireless network and an encryption key for communication on the wireless network.

22. A machine-readable medium including instructions which when executed by a machine causes the machine to perform operations comprising:
receiving input to locate a device not configured to access a wireless network;
changing communication on the wireless network to a configuration channel; and
transmitting wireless configuration data to the device not configured to access the wireless network, in response to establishing communication with the device over the configuration channel.

23. The machine-readable medium of claim 22, wherein receiving input to locate the device not configured to access the wireless network comprises receiving input to locate a digital music receiver not configured to access the wireless network.

24. The machine-readable medium of claim 22, wherein transmitting the wireless configuration data comprises transmitting an identification of the wireless network.

25. The machine-readable medium of claim 22, wherein transmitting the wireless configuration data comprises transmitting an encryption key for communication on the wireless network.

26. An apparatus comprising:
a wireless communication transmitter to transmit a wireless communication that cannot be transmitted through an opaque material, the wireless communication to include an identification of the apparatus and to be received by a wireless remote control; and
an input module to receive a control signal from the wireless remote control to control the apparatus after the wireless communication is received by the wireless remote control.

27. The apparatus of claim 26, wherein the wireless communication that cannot be transmitted through an opaque material comprises an infrared communication.

28. A method comprising:
transmitting, from an apparatus, a wireless communication that cannot be transmitted through an opaque material, wherein the wireless communication includes an identification of the apparatus; and
receiving a control signal, from a wireless remote control that received the wireless communication, to control the apparatus.

29. An apparatus comprising:
a wireless communication module to receive a wireless communication, from an electronic device, that cannot be transmitted through an opaque material, the wireless communication to include an identification of the electronic device; and
an output module to transmit a wireless control communication to control the electronic device after the wireless communication is received by the apparatus.

30. The apparatus of claim 29, wherein the wireless communication that cannot be transmitted through an opaque material comprises an infrared communication.

31. The apparatus of claim 29, further comprising a microphone to receive a voice command that is for distribution of multimedia content to the electronic device or a different electronic device.

32. The apparatus of claim 29, further comprising a wireless communication module to output a wireless communication for the multimedia content to be distributed to the electronic device or to the different electronic device.

33. A method comprising:
receiving a wireless communication, from an apparatus, that cannot be transmitted through an opaque material, the wireless communication to include an identification of the apparatus; and
transmitting a control wireless communication to the apparatus to control the apparatus.

34. The method of claim 33, further comprising configuring to control the apparatus, wherein the control wireless communication is based on the configuring.
